(19) United States
(12) Patent Application Publication
(10) Pub. No.: US 2008/0303991 A1
(43) Pub. Date: Dec. 11, 2008

(54) PIXEL UNIT

(75) Inventors: Wen-Chun Wang, Taichung City (TW); Chin-Chang Liu, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/132,627

(22) Filed: Jun. 4, 2008

(30) Foreign Application Priority Data
Jun. 5, 2007 (TW) 96120074

(51) Int. Cl. G02F 1/1335

(52) U.S. Cl. 349/106; 349/114

(57) ABSTRACT

A pixel unit of a transflective liquid crystal display (LCD) is provided. The pixel unit is suitable for being disposed between an upper substrate and a lower substrate. The pixel unit includes an active device, a reflective color filter, a common electrode and a liquid crystal layer. The active device and the reflective color filter are both disposed on the lower substrate, and the active device is electrically connected with the reflective color filter. The common electrode is disposed on the upper substrate, and the liquid crystal layer is disposed between the reflective color filter and the common electrode. It should be noted that the reflective color filter includes a reflective film, a spacer layer, a transflective film, and a transparent optical film stacked sequentially. With such a design, the display quality of the pixel unit is improved.

### CROSS-REFERENCE TO RELATED APPLICATION

This application claims the priority benefit of Taiwan application serial no. 96120074, filed on Jun. 5, 2007. The entirety of the above-mentioned patent application is hereby incorporated by reference herein and made a part of specification.

### BACKGROUND OF THE INVENTION

1. Field of the Invention

The present invention generally relates to a transflective liquid crystal display (LCD) and a pixel unit thereof, in particular, to a pixel unit having both high color saturation and high brightness.

2. Description of Related Art

A liquid crystal display (LCD) is not a kind of self-emissive display, thus, an external light source has to be used for providing enough luminance to the LCD panel. LCDs can be categorized into transmissive LCDs, transflective LCDs, and reflective LCDs according to the light sources they use. A transmissive LCD uses a backlight module as its light source therefore the transmissive LCD consumes a lot of power and accordingly it is not suitable for portable products such as cell phones, personal digital assistants (PDAs), and e-books. To reduce the power consumption of a LCD, transflective LCD and reflective LCD which use external light sources have become the mainstream of LCD development.

FIG. 1 is a cross-sectional view of a reflective region in a conventional pixel unit. Referring to FIG. 1, the conventional pixel unit 100 includes a common electrode 112, a color filter layer 114, a pixel electrode 122, a reflective layer 124, and a liquid crystal layer 130. The common electrode 112 is disposed on an upper substrate 110, and the pixel electrode 122 is disposed on a lower substrate 120. The pixel electrode 122 and the reflective layer 124 are disposed on the lower substrate 120, and the reflective layer 124 is disposed below the pixel electrode 122 of the pixel unit 100 for reflecting an external light (as denoted by the arrow in FIG. 1). In addition, the liquid crystal layer 130 is disposed between the common electrode 112 and the pixel electrode 122. To provide colorful display, the conventional pixel unit 100 may further include a color filter layer 114 disposed between the upper substrate110 and the common electrode 112.

It should be noted that the intensity of light passed through the color filter layer 114 is greatly reduced because the color filter layer 114 filters out part of the external light and only allows the light within certain wavelength range to pass through. An aperture can be formed in the color filter layer 114 in order to increase the display brightness of the pixel unit 100; however, the aperture may reduce the color saturation of an image displayed by the pixel unit 100. In other words, the conventional pixel unit 100 cannot have both high brightness and high color saturation.

### SUMMARY OF THE INVENTION

Accordingly, the present invention is directed to a pixel unit having both high brightness and high color saturation.

The present invention provides a pixel unit suitable for being disposed between an upper substrate and a lower substrate. The pixel unit includes an active device, a reflective color filter, a common electrode, and a liquid crystal layer. The active device and the reflective color filter are both disposed on the lower substrate, and the reflective color filter is electrically connected with the active device. The common electrode is disposed on the upper substrate, and the liquid crystal layer is disposed between the reflective color filter and the common electrode. It should be noted that the reflective color filter includes a reflective film, a spacer layer, a transflective film, and a transparent optical film, wherein the spacer layer is disposed on the reflective film, the transflective film is disposed on the spacer layer, and the transparent optical film is disposed on the transflective film.

The present invention further provides a pixel unit suitable for being disposed between an upper substrate and a lower substrate. The pixel unit includes a reflective color filter, a common electrode, and a liquid crystal layer. The reflective color filter is disposed on the lower substrate. The common electrode is disposed on the upper substrate, and the liquid crystal layer is disposed between the reflective color filter and the common electrode. It should be noted that the reflective color filter includes a reflective film, a spacer layer, a transflective film, and a transparent optical film, wherein the spacer layer is disposed on the reflective film, the transflective film is disposed on the spacer layer, and the transparent optical film is disposed on the transflective film.

According to an embodiment of the present invention, the material of the reflective film includes aluminum alloy or silver, the material of the spacer layer includes silicon nitride or silicon oxide, the material of the transflective film may be chromium, and the transflective film may be electrically connected with the reflective film.

According to an embodiment of the present invention, the transparent optical film includes a transparent conductive layer, and the material of the transparent conductive layer may be indium tin oxide (ITO) or indium zinc oxide (IZO). In addition, the transparent conductive layer may be extended from the transflective film to outside of the transflective film so as to define a transmissive region beside the transflective film. Accordingly, the pixel unit may further include a padding layer disposed on the reflective color filter or between the reflective color filter and the lower substrate. In addition, a color filter layer located above the transmissive region may be further disposed on the upper substrate.

According to an embodiment of the present invention, the material of the transparent optical film may be polyimide.

According to an embodiment of the present invention, the reflective color filter further includes a transparent electrode disposed between the reflective film and the lower substrate. The transparent electrode is electrically connected with the active device and is extended from below the reflective film to outside of the reflective film so as to define a transmissive region beside the reflective film.

According to an embodiment of the present invention, the pixel unit may further include a padding layer disposed on the reflective color filter, between the transparent electrode and the lower substrate, or between the reflective film and the transparent electrode. If the padding layer is disposed between the reflective film and the transparent electrode, the pixel unit may further include a conductive contact hole located in the padding layer such that the reflective film can be electrically connected with the transparent electrode via the conductive contact hole.

The present invention further provides a pixel unit of a transflective liquid crystal display (LCD). The pixel unit includes an active device, a reflective color filter, a transmissive electrode layer, a common electrode, and a liquid crystal layer. The active device and the reflective color filter are disposed on the lower substrate, and the reflective color filter is electrically connected with the active device. The transmissive electrode layer is disposed on the lower substrate and is located at one side of the reflective color filter, and the transmissive electrode layer is electrically connected with the reflective color filter. The common electrode is disposed on the upper substrate, and the liquid crystal layer is disposed between the reflective color filter, the transmissive electrode layer and the common electrode. It should be noted that the reflective color filter includes a reflective film, a spacer layer, a transflective film, and a transparent optical film, wherein the spacer layer is disposed on the reflective film, the transflective film is disposed on the spacer layer, and the transparent optical film is disposed on the transflective film.

According to an embodiment of the present invention, the portion of the transmissive electrode layer overlapped with the reflective color filter is a reflective region, and the portion of the transmissive electrode layer not overlapped with the reflective color filter is a transmissive region.

According to an embodiment of the present invention, the transflective film is electrically connected with the reflective film.

According to an embodiment of the present invention, the pixel unit may further include a padding layer disposed on the reflective color filter or below, the reflective color filter. In addition, the transflective film may be electrically connected with the reflective film.

According to an embodiment of the present invention, the pixel unit may further include a color filter layer disposed on the upper substrate, wherein the color filter layer is located between the transmissive electrode layer and the upper substrate.

The present invention further provides yet another pixel unit suitable for being disposed between an upper substrate and a lower substrate. The pixel unit includes a reflective color filter, a transparent electrode, and a liquid crystal layer. The reflective color filter is disposed on the lower substrate and includes a reflective film, a spacer layer, a transflective film, and a transparent optical film. The spacer layer is disposed on the reflective film, the transflective film is disposed on the spacer layer, the transparent optical film is disposed on the transflective film, and the transparent electrode is disposed on the upper substrate. In addition, the liquid crystal layer is disposed between the reflective color filter and the transparent electrode.

In a pixel unit provided by the present invention, the light reflected by the reflective color filter has a specific wavelength, and the wavelength of the light reflected by the reflective color filter is related to the thickness of the spacer layer. On the other hand, in a pixel unit of the present invention, the incident and reflected lights do not pass through the conventional color filter layer, thus, the intensities of the incident and reflected lights will not be reduced by the color filter layer. Accordingly, an image displayed by a pixel unit in the present invention has both high brightness and high color saturation.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a reflective region in a conventional pixel unit.

FIG. 2A is a cross-sectional view of a pixel unit according to a first embodiment of the present invention.

FIGS. 2B˜2D illustrate the relationships between the wavelengths of various color lights and the reflective ratio of a reflective color filter according to an embodiment of the present invention.

FIGS. 2E˜2G illustrate the relationships between the wavelengths of various color lights and the reflective ratio of a reflective color filter according to another embodiment of the present invention.

FIG. 3A is a cross-sectional view of a pixel unit according to a second embodiment of the present invention.

FIG. 3B and FIG. 3C are diagrams illustrating two structures having dual cell gaps in a liquid crystal layer of a pixel unit 300A.

FIG. 4A is a cross-sectional view of a pixel unit according to a third embodiment of the present invention.

FIGS. 4B˜4E are diagrams illustrating four structures having different cell gaps in a liquid crystal layer of a pixel unit 400A.

FIG. 5 is a cross-sectional view of a pixel unit according to a fourth embodiment of the present invention.

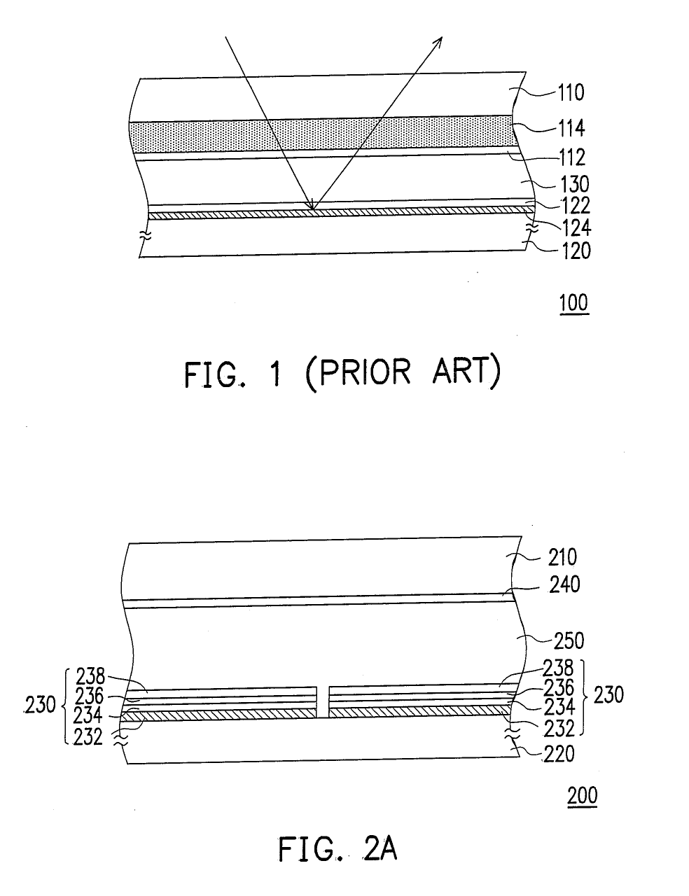

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention provides a pixel unit having a reflective color filter in order to allow a liquid crystal display (LCD) to have both high brightness and high color saturation.

### First Embodiment

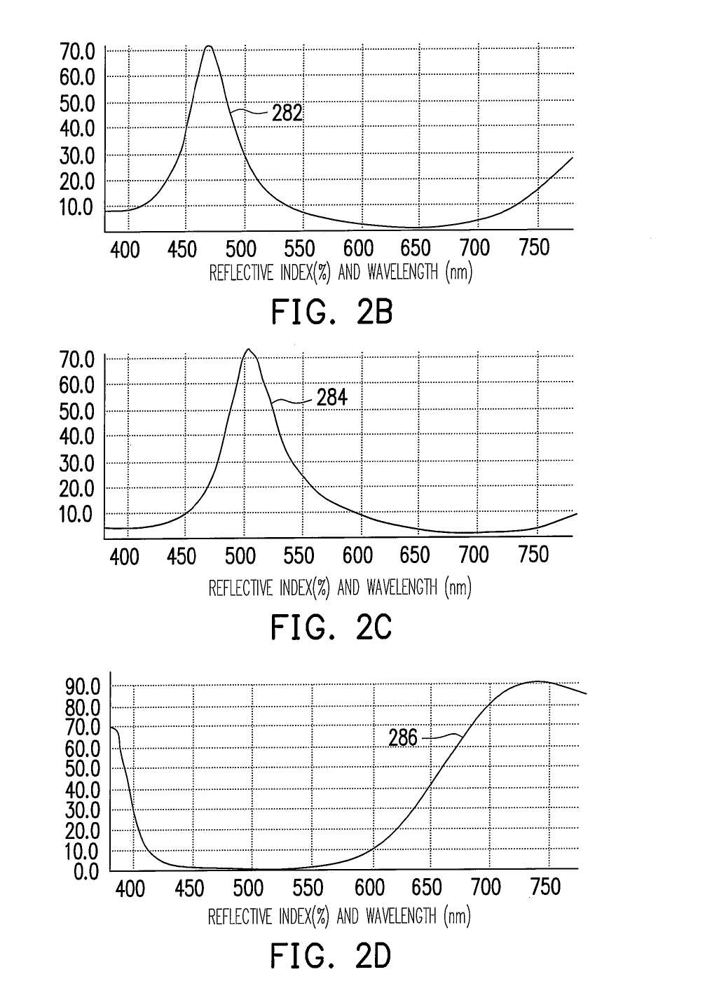

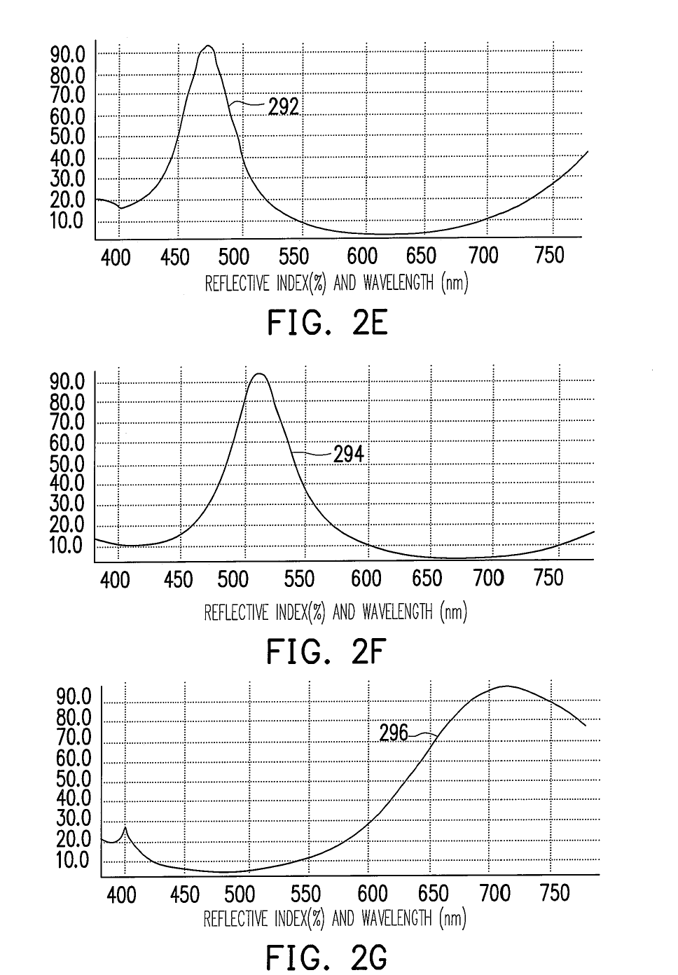

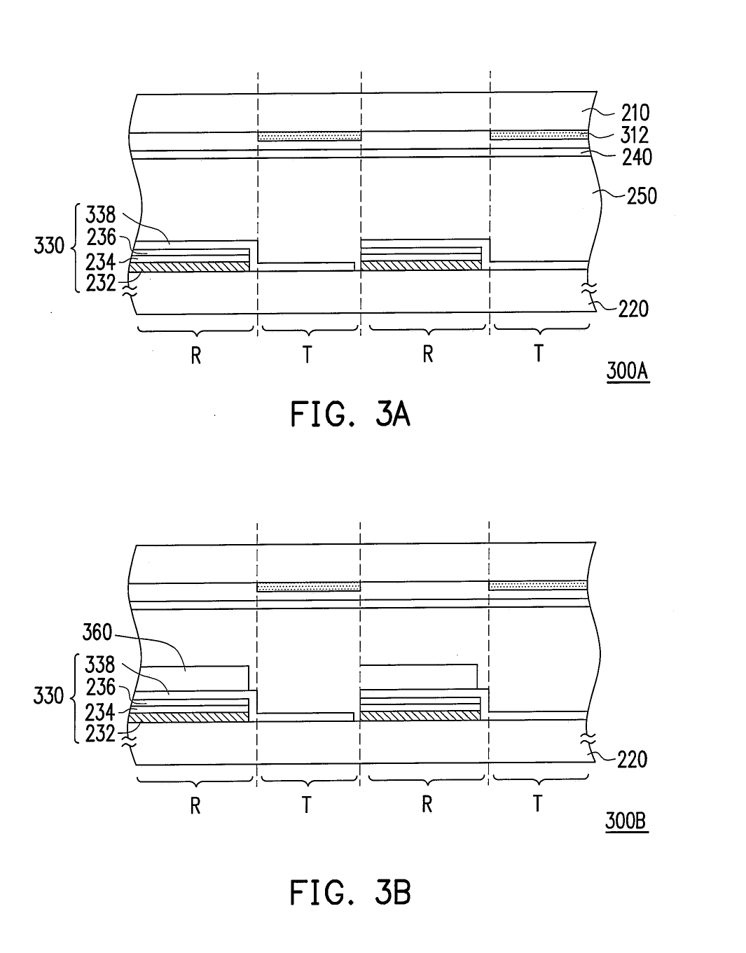

FIG. 2A is a cross-sectional view of a pixel unit according to the first embodiment of the present invention. Referring to FIG. 2A, a plurality of pixel units 200 (only two are illustrated demonstratively) is disposed between an upper substrate 210 and a lower substrate 220. Each pixel unit 200 includes an active device (not shown), a reflective color filter 230, a common electrode 240, and a liquid crystal layer 250. The active device (not shown) and the reflective color filter 230 are both disposed on the lower substrate 220, and the reflective color filter 230 is electrically connected with the active device (not shown). The active device serves as a switch, such as a thin film transistor or a diode. The common electrode 240 is disposed on the upper substrate 210, and the liquid crystal layer 250 is disposed between the reflective color filter 230 and the common electrode 240.

It should be noted that the reflective color filter 230 includes a reflective film 232, a spacer layer 234, a transflective film 236, and a transparent optical film 238, wherein the spacer layer 234 is disposed on the reflective film 232, the transflective film 236 is disposed on the spacer layer 234, and the transparent optical film 238 is disposed on the transflective film 236. The transflective film 236 may be electrically connected with the reflective film 232 in order to improve the display quality of the LCD and reduce the impedance in the pixel unit 200.

In the present embodiment, the material of the reflective film 232 includes aluminum alloy or silver, and the material of the spacer layer 234 includes silicon nitride or silicon oxide. The material of the transflective film 236 may be chromium, and the material of the transparent optical film 238 includes polyimide, indium tin oxide (ITO), indium zinc oxide (IZO), or other transparent conductive material.

In each pixel unit 200, the transflective film 236 and the reflective film 232 in the reflective color filter 230 respectively reflect lights, and the interference effect may be produced to the reflected lights. In other words, the light passed through the reflective color filter 230 has a specific wavelength, and the specific wavelength is related to the thickness of the spacer layer 234.

According to our experiences, if the reflective film 232 is fabricated of AlNd, the spacer layer 234 may be fabricated of silicon nitride, the transflective film 236 may be fabricated of chromium, and the transparent optical film 238 may be fabricated of ITO, the thickness of the spacer layer 234 can be respectively 208 nm, 225 nm, and 162 nm in order to allow the reflective color filter 230 to provide blue, green, and red light. The relationships between the wavelengths of the blue, green, and red light and the reflective ratio of the reflective color filter 230 are respectively as 282, 284, and 286 illustrated in FIG. 2B, FIG. 2C, and FIG. 2D.

If the reflective film 232 is fabricated of silver, the spacer layer 234 may be fabricated of silicon nitride, the transflective film 236 may be fabricated of chromium, and the transparent optical film 238 may be fabricated of polyimide, the thickness of the spacer layer 234 can be respectively 202 nm, 223 nm, and 150 nm in order to allow the reflective color filter 230 to provide blue, green, and red light. The relationships between the wavelengths of the blue, green, and red light and the reflective ratio of the reflective color filter 230 are respectively as 292, 294, and 296 illustrated in FIG. 2E, FIG. 2F, and FIG. 2G.

As described above, with the reflective film 232, the spacer layer 234, the transflective film 236, and the transparent optical film 238 fabricated of the above-mentioned materials, the pixel unit 200 can display different colors, for example, red, green, and blue, by adjusting the thickness of the spacer layer 234. It should be noted that in FIGS. 2B˜2D, the reflective ratio of various color lights are all above 70%, while in FIGS. 2E˜2G, the reflective ratio of various color lights are even over 90%. In short, the pixel unit 200 has both high brightness and high color saturation. In addition, according to the present invention, the pixel unit 200 may not have the active device, namely, the pixel unit 200 may also be a passive pixel unit. In other words, the pixel unit 200 may be applied to a super twisted nematic liquid crystal display (STN-LCD) or a twisted nematic liquid crystal display (TN-LCD).

### Second Embodiment

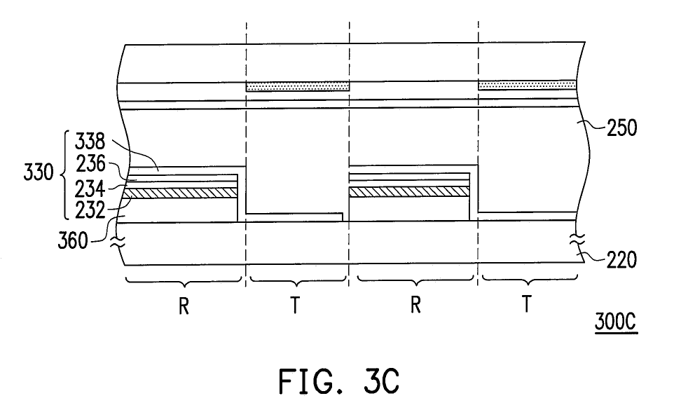

FIG. 3A is a cross-sectional view of a pixel unit according to the second embodiment of the present invention. Referring to FIG. 3A, the pixel unit 300A is similar to the pixel unit 200 except that, in the pixel unit 300A, a transparent conductive layer 338 is disposed in the reflective color filter 330 to serve as the transparent optical film, and the transparent conductive layer 338 is extended from the transflective film 236 to outside of the transflective film 236 so as to define a transmissive region T. Meanwhile, the reflective film 232 in the pixel unit 300A defines a reflective region R. In other words, the pixel unit 300A has a reflective region R and a transmissive region T. The reflective color filter 330 is disposed on a portion of the lower substrate 220 to define the reflective region R of the pixel unit 300A. Accordingly, the pixel unit 300A is a transflective pixel unit. In the present embodiment, the material of the transparent conductive layer 338 may be ITO or IZO.

As shown in FIG. 3A, the pixel unit 300A may further include a color filter layer 312 disposed on the upper substrate 210, and the color filter layer 312 is located within the transmissive region T. The color filter layer 312 may filter different color, such as red, green, or blue. Here, the pixel unit 300A can provide colorful display in both reflective mode and transmissive mode.

The pixel unit 300A has a single cell gap, and two structures having dual cell gaps in the liquid crystal layer of the pixel unit 300A will be described below with reference to FIG. 3B and FIG. 3C.

First, referring to both FIG. 3A and FIG. 3B, the pixel unit 300B is similar to the pixel unit 300A. However, the pixel unit 300B further includes a padding layer 360 disposed on the reflective color filter 330. The material of the padding layer 360 may be a transparent dielectric material.

Referring to both FIG. 3A and FIG. 3C, the design of the pixel unit 300C is originated from the pixel unit 300A. However, in the pixel unit 300C, a padding layer 360 is further disposed below the reflective color filter 330. Here the purpose of the padding layer 360 is to allow the liquid crystal layer 250 to have dual cell gaps. Actually, according to the present invention, an alignment film (not shown) covering the transparent conductive layer 338 may be disposed on the lower substrate 220 in the pixel unit 300A, 300B, or 300C to adjust the arrangement of liquid crystal molecules in the liquid crystal layer 250.

### Third Embodiment

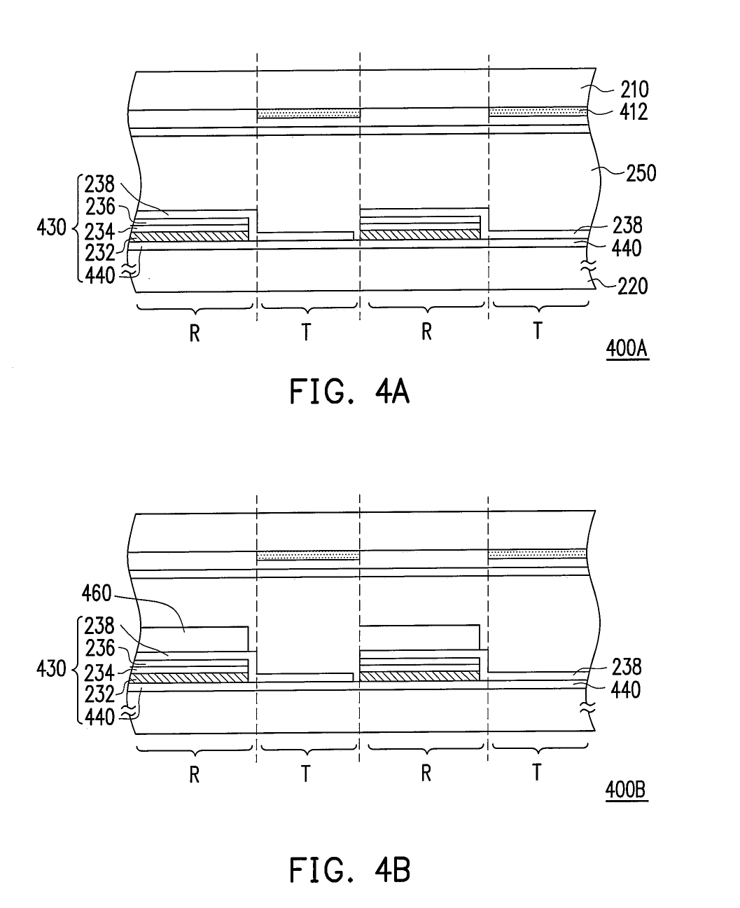

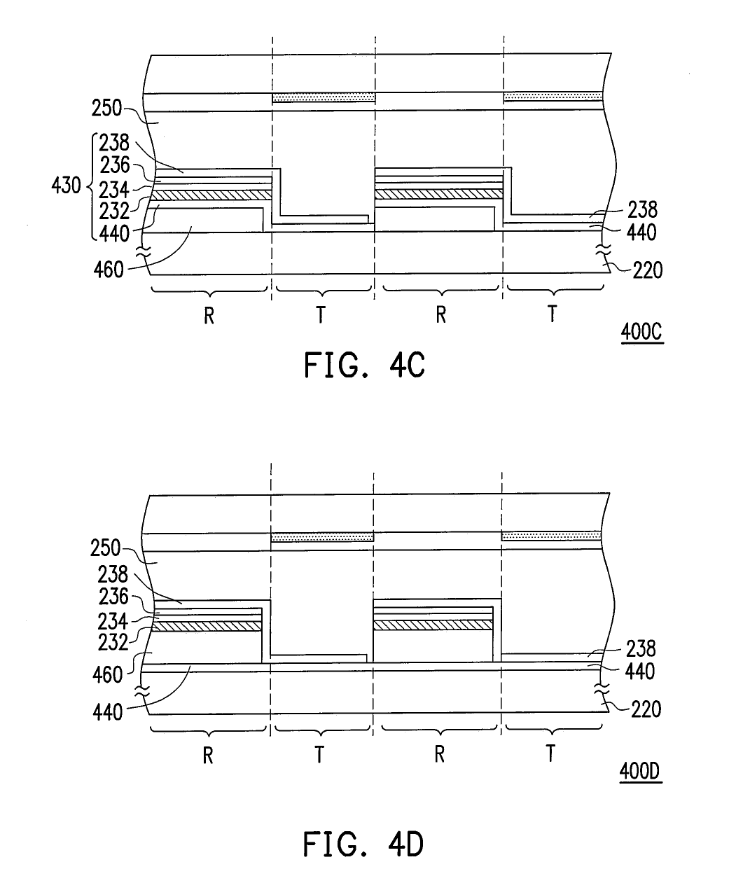

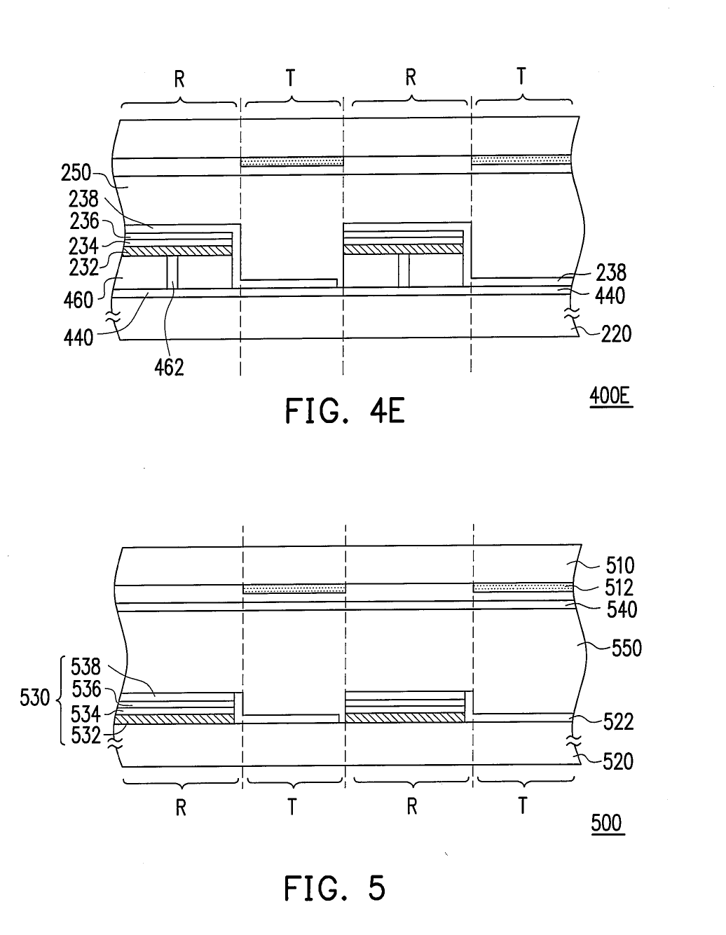

FIG. 4A is a cross-sectional view of a pixel unit according to the third embodiment of the present invention. Referring to FIG. 4A, the pixel unit 400A is similar to the pixel unit 200. Specifically, the pixel unit 400A may further includes a transparent electrode 440 disposed between the reflective film 232 of the reflective color filter 430 and the lower substrate 220. The transparent electrode 440 is electrically connected with an active device (not shown), and the transparent electrode 440 may be extended from below the reflective film 232 to outside of the reflective film 232.

As shown in FIG. 4A, the transparent electrode 440 defines a transmissive region T beside the reflective film 232, and the reflective film 232 defines a reflective region R. Accordingly, the pixel unit 400A is a transflective pixel unit. To improve the display quality of the pixel unit 400A, a color filter layer 412 may be disposed on the upper substrate 210, and the color filter layer 412 may be located within the transmissive region T.

In the present embodiment, the material of the transparent optical film 238 may be a transparent polymer such as polyimide. Meanwhile, the transparent optical film 238 may be extended from the transflective film 236 outwards to the transparent electrode 440 (as shown in FIG. 4A). In addition, the transparent optical film 238 can be directly used as an alignment film if it is fabricated of polyimide. With such a design, the process and cost for fabricating an alignment film can be saved. In another embodiment of the present invention, the material of the transparent optical film 238 may also be a transparent conductive material such as ITO or IZO.

The pixel unit 400A has the advantages of the pixel unit 200, namely, an image displayed by the pixel unit 400A have both high brightness and high color saturation.

Several embodiments of the present invention are further illustrated in FIGS. 4B˜4E wherein the pixel unit 400A is allowed to have dual cell gaps by disposing a padding layer 460 made of a transparent dielectric material. First, referring to FIG. 4B, the pixel unit 400B further includes a padding layer 460 disposed on the reflective color filter 430. In addition, as shown in FIG. 4C, in the pixel unit 400C, the padding layer 460 is disposed between the reflective color filter 430 and the lower substrate 220. While in the pixel unit 400D as shown in FIG. 4D, the padding layer 460 is disposed between the reflective film 232 and the transparent electrode 440.

By disposing a padding layer 460, the liquid crystal layer 250 can have dual cell gaps, and accordingly the display quality of the pixel unit 400B, 400C, or 400D can be improved.

Next, referring to FIG. 4E, if the padding layer 460 is disposed between the reflective film 232 and the transparent electrode 440, the pixel unit 400E may further include a conductive contact hole 462 disposed in the padding layer 460. By disposing the conductive contact hole 462 in the padding layer 460, the reflective film 232 is electrically connected with the transparent electrode 440, so that the problems caused by floated reflective film 232 and transflective film 236 are avoided, and accordingly the quality of the pixel unit 400E is further improved.

### Fourth Embodiment

The present invention further provides a transflective pixel unit. FIG. 5 is a cross-sectional view of a transflective pixel unit 500 according to the fourth embodiment of the present invention. Referring to FIG. 5, the pixel unit 500 is suitable for being disposed between an upper substrate 510 and a lower substrate 520, and the pixel unit 500 includes an active device (not shown), a reflective color filter 530, a transmissive electrode layer 522, a common electrode 540, and a liquid crystal layer 550.

In the pixel unit 500, the active device (not shown) and the reflective color filter 530 are disposed on the lower substrate 520, and the reflective color filter 530 is electrically connected with the active device (not shown). The transmissive electrode layer 522 is disposed on the lower substrate 520 and is located at one side of the reflective color filter 530, and the transmissive electrode layer 522 is electrically connected with the reflective color filter 530. The common electrode 540 is disposed on the upper substrate 510, and the liquid crystal layer 550 is disposed between the reflective color filter 530, the transmissive electrode layer 522 on the lower substrate 520 and the common electrode 540 on the upper substrate 510.

It should be noted that the reflective color filter 530 includes a reflective film 532, a spacer layer 534, a transflective film 536, and a transparent optical film 538. The spacer layer 534 is disposed on the reflective film 532, the transflective film 536 is disposed on the spacer layer 534 and is electrically connected with the reflective film 532, and the transparent optical film 538 is disposed on the transflective film 536. With such a design of the reflective color filter 530, the display quality of the pixel unit 500 can be improved.

In the pixel unit 500, the transmissive electrode layer 522 defines a transmissive region T at one side of the reflective color filter 530, and the reflective color filter 530 defines a reflective region R. Accordingly, the pixel unit 500 is a transflective pixel unit.

As shown in FIG. 5, to further improve the display quality of the pixel unit 500, the pixel unit 500 may further include a color filter layer 512 disposed on the upper substrate 510, and the color filter layer 512 is located on the transmissive electrode layer 522. In another embodiment of the present invention, the pixel unit 500 may further include a padding layer (not shown) disposed on the reflective color filter 530 or below the reflective color filter 530.

In an embodiment of the present invention, the material of the reflective film 532 may be aluminum alloy or silver, the material of the spacer layer 534 may be silicon nitride or silicon oxide, the material of the transflective film 536 may be chromium, and the material of the transparent optical film 538 may be polyimide, ITO, or IZO.

If the transparent optical film 538 is fabricated of polyimide or other polymer, the transparent optical film 538 can serve as an alignment film on one surface thereof in contact with the liquid crystal layer 550. Meanwhile, the transparent optical film 538 can be extended from the transflective film 536 outwards to the transmissive electrode layer 522 to serve as an alignment film, so that the process and cost for fabricating an alignment film additionally can be saved.

In overview, the pixel unit in the present invention has at least following advantages:

(1) the design of a reflective color filter in the pixel unit produces interference to the reflected lights, thus, the pixel unit can provide colorful image display.

(2) when the pixel unit displays an image in a reflective mode, the incident and reflected lights will not be reduced by the conventional color filter layer, thus, the image displayed by the pixel unit has high brightness.

(3) according to our experiences, the pixel unit has both high brightness and high color saturation.

(4) according to some embodiments of the present invention, the transparent optical film in the pixel unit is fabricated of polymer material, thus, the transparent optical film can serve as an alignment film, and accordingly the process for fabricating an alignment film can be saved.

(5) according to some embodiments of the present invention, a transmissive region can be defined beside the reflective color filter through different designs so as to form a transflective pixel unit.

(6) according to some embodiments of the present invention, the liquid crystal layer can have dual cell gaps by disposing a padding layer, thus, the display quality of the pixel unit can be improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel unit disposed between an upper substrate and a lower substrate, comprising:
an active device, disposed on the lower substrate;
a reflective color filter, disposed on the lower substrate, the reflective color filter being electrically connected with the active device, the reflective color filter comprising:
a reflective film;
a spacer layer, disposed on the reflective film;
a transflective film, disposed on the spacer layer; and
a transparent optical film, disposed on the transflective film;
a common electrode, disposed on the upper substrate; and
a liquid crystal layer, disposed between the reflective color filter and the common electrode.

2. The pixel unit according to claim 1, wherein the transparent optical film comprises a transparent conductive layer.

3. The pixel unit according to claim 2, wherein a material of the transparent conductive layer comprises indium tin oxide (ITO) or indium zinc oxide (IZO).

4. The pixel unit according to claim 2, wherein the pixel unit has a reflective region and a transmissive region, the reflective color filter being disposed on a portion of the lower substrate to define the reflective region and the transparent conductive layer being extended from the transflective film to outside of the transflective film to define the transmissive region.

5. The pixel unit according to claim 4, further comprising a color filter layer disposed on the upper substrate, wherein the color filter layer is over the transparent conductive layer in the transmissive region.

6. The pixel unit according to claim 4, further comprising a padding layer disposed on the reflective color filter.

7. The pixel unit according to claim 4, further comprising a padding layer disposed between the reflective color filter and the lower substrate.

8. The pixel unit according to claim 4, wherein the transparent electrode of the reflective color filter is disposed between the reflective film and the lower substrate, and the transparent electrode is electrically connected with the active device and is extended into the transmissive region.

9. The pixel unit according to claim 9, further comprising a padding layer disposed on the reflective color filter.

10. The pixel unit according to claim 9, further comprising a padding layer disposed between the transparent electrode and the lower substrate.

11. The pixel unit according to claim 9, further comprising a padding layer disposed between the reflective film and the transparent electrode.

12. The pixel unit according to claim 9, further comprising a conductive contact hole located in the padding layer for electrically connecting the reflective film and the transparent electrode.

13. The pixel unit according to claim 1, wherein the transflective film is electrically connected with the reflective film.

14. The pixel unit according to claim 1, wherein a material of the transparent optical film comprises polyimide.

15. The pixel unit according to claim 1, wherein a material of the reflective film comprises aluminum alloy or silver.

16. The pixel unit according to claim 1, wherein a material of the spacer layer comprises silicon nitride or silicon oxide.

17. The pixel unit according to claim 1, wherein a material of the transflective film comprises chromium.

18. A pixel unit disposed between an upper substrate and a lower substrate, comprising:
an active device, disposed on the lower substrate;
a reflective color filter, disposed on the lower substrate, the reflective color filter being electrically connected with the active device, the reflective color filter comprising:
a reflective film;
a spacer layer, disposed on the reflective film;
a transflective film, disposed on the spacer layer; and
a transparent optical film, disposed on the transflective film;
a transmissive electrode layer, disposed on the lower substrate and located at one side of the reflective color filter, the transmissive electrode layer being electrically connected with the reflective color filter;
a common electrode, disposed on the upper substrate; and
a liquid crystal layer, disposed between the reflective color filter, the transmissive electrode layer and the common electrode.

19. The pixel unit according to claim 18, wherein a part of the transmissive electrode layer is overlapped with the reflective color filter.

20. The pixel unit according to claim 19, wherein the part of the transmissive electrode layer overlapped with the reflective color filter is a reflective region, and a part of the transmissive electrode layer not overlapped with the reflective color filter is a transmissive region.

21. The pixel unit according to claim 18, wherein the transflective film is electrically connected with the reflective film.

22. The pixel unit according to claim 18, wherein a material of the transparent optical film comprises polyimide, indium tin oxide (ITO), or indium zinc oxide (IZO).

23. The pixel unit according to claim 18, wherein a material of the spacer layer comprises silicon nitride or silicon oxide.

24. A pixel unit disposed between an upper substrate and a lower substrate, comprising:
a reflective color filter, disposed on the lower substrate, the reflective color filter comprising:
a reflective film;
a spacer layer, disposed on the reflective film;
a transflective film, disposed on the spacer layer; and
a transparent optical film, disposed on the transflective film;
a transparent electrode, disposed on the upper substrate; and
a liquid crystal layer, disposed between the reflective color filter and the transparent electrode.
